(19) United States
(12) Patent Application Publication
(10) Pub. No.: US 2011/0294094 A1
(43) Pub. Date: Dec. 1, 2011

(54) Implant and method

(76) Inventor: Mark Moshavi, Bat Yam (IL)

(21) Appl. No.: 12/805,348

(22) Filed: Jul. 27, 2010

Related U.S. Application Data
(60) Provisional application No. 61/396,664, filed on Jun. 1, 2010.

(51) Int. Cl. A61C 8/00

(52) U.S. Cl. 433/174

(57) ABSTRACT

Disclosed is an implant, particularly to be employed in implant operations, to be implanted in bone tissue. Such implants may assist in reducing pressure of the implant on the surrounding bone tissue.

The abstract of the disclosure is submitted herewith as required various rules and regulations of different Patent Offices. A purpose of the abstract is to enable the Patent Offices and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

The present application claims priority from U.S. Provisional Application Ser. No. 61/396,664, entitled “Implant and Method” and filed on Jun. 1, 2010 incorporated herein by reference in its entirety.

### FIELD OF THE DISCLOSURE

The present disclosure may generally relate to implants designed to be used in a variety of dental, medical, and surgical procedures where it is desired to embed a mechanical attachment into living bone, as well as a method of applying such implants to bone tissues, so as it may assist in reducing pressure of the implant on the surrounding bone tissue.

### BACKGROUND

The foregoing examples of the related art and limitations related therewith are intended to be illustrative and not exclusive. Other limitations of the related art will become apparent to those of skill in the art upon a reading of the specification and a study of the figures. An illustrative example of a procedure that uses implants may be dental prosthesis using embedded implants. However, such exemplary and illustrative purpose, and the related description and drawings herein, should be interpreted by way of illustrative purpose without limiting the scope and sprit of the present disclosure. Other types of procedures may well be considered as applicable for the utilization of the presently disclosed implant.

As an illustrative example, dental implants may provide a desirable prosthesis for patients who are missing one or more natural teeth. A dental implant may include an implant that may be embedded into the jawbone and a prosthetic tooth that is attached to and supported by the implant. The prosthetic tooth may be attached directly to the implant or an abutment fixture may be attached to the implant and support the prosthetic tooth in turn. An appropriate implant will support bone growth that invades the implant such that the implant becomes integrated with the surrounding bone in a process termed osseointegration. However, other types of implants, designed to be embedded and/or integrated with living bone tissue, may also be included in the spirit and scope of the present disclosure.

An implant to support a prosthetic tooth may be embedded in what is termed a two-stage procedure. In the first stage, the implant is embedded into the jawbone and the surgical site is then closed. After a period of months the implant will achieve osseointegration. The site of the implant is then re-opened surgically to allow the attachment of a prosthetic tooth.

Other techniques may be employed that permit a dental implant to be embedded in a one-stage procedure. In a one-stage procedure, the implant is embedded and a prosthetic tooth is immediately fitted. The immediately fitted prosthetic tooth may be an interim prosthesis that allows the soft tissue to properly heal and maintains the spacing and alignment of adjacent teeth during the period of osseointegration. A permanent prosthetic tooth may be fitted at a later date after at least some osseointegration has occurred, generally without requiring an additional surgical procedure.

To achieve successful osseointegration it is desirable that the implant fit closely into the surrounding bone. It may also be desired that the implant may not move relative to the surrounding bone during the period of osseointegration. Where the implant cannot be closely fitted to the surrounding bone, it may be necessary to use bone-grafting materials to fill the space between the implant and the surrounding bone.

“Implant Stability Quotient” (see, for example, http://en.wikipedia.org/wiki/Implant_stability_quotient, incorporated herein by reference, in its entirety) may be highly relevant to osseointegration and thus to long-term implantation success. As quoted by the above reference, “. . . Higher values are generally found in the mandible (http://en.wikipedia.org/wiki/Mandible) than the maxilla (http://en.wikipedia.org/wiki/Maxilla). High initial stability (ISQ values of 70 and above) tends to not increase with time, even if the high mechanical stability will decrease to be replaced by a developed biological stability. Lower initial stability will normally increase with time due to the lower mechanical stability being enforced by the bone remodeling process (osseointegration) . . . ”. The above quoted statement considering possible reduction of ISQ values over time in otherwise initially tight (i. e., high initial stability) implantations may be that bone chips and/or tissue remnants and/or fragments which may be packed about the implant, may exert excess pressure on the surrounding bone, and may cause re-absorption of solid bone tissue in which the implant may be embedded.

The inverse stipulation may hold true for loose (i. e., lower initial stability) implantations, which, as quoted above, may tent to increase in stability “. . . due to the lower mechanical stability” which may facilitate bone remodeling process, or osseointegration, but may not offer enough ISQ which may be sufficient for immediate loading procedures.

As an example, U.S. Pat. No. 5,897,319 to Wagner, William R., Armstrong, Peter S., and Bassett, Jeffrey A., shows in FIGS. 4 and 5 therein, and discloses, generally, “A self-tapping dental implant for implantation into bone. The implant includes multiple flutes disposed around the tapping end. Each flute has a helical configuration. During tapping, bone chips are directed upwardly and away from the tapping end”. Moreover, “FIG. 5 shows a cross-section of implant 10 after being tapped into hole 70. Bone chips 80 have moved into the rough surface conditions (FIG. 4, or FIG. 1a herein) adjacent coronal end 12. The surface adjacent the coronal end is now more smooth and contains less defects. FIG. 5 also reveals that bone chips 82 have been directed around the exterior of the tapping end of the implant. Other bone chips 84 exist in the threads located between the termination point and the coronal end. Bone chips 82 and 84 pack tightly around the implant and increase the overall stability of the implant.” (FIGS. 4 and 5 of U.S. Pat. No. 5,897,319 are shown and referred to herein as FIG. 1a and FIG. 1b, respectively, titled “Prior Art 1”).

As a further example, U.S. Pat. No. 5,676,545 shows in FIG. 5 therein, and discloses, generally, “A side view of the crumb-distributing implant 47 is shown in FIG. 5. The implant 47 is a solid cylinder with screw threads 49 extending from the distal end to the terminal portion 51 of the implant. The terminal portion 51 provides the means for attaching a prosthesis.

“At least one helical channel 53 is embedded in the surface of the implant throughout the threaded portion. The intersection of the helical channel with the threads results in the threads having cutting edges which permit the implant to cut its own threads in bone tissue when it is installed. To facilitate the thread-cutting process, the threaded portion has a tapered section 55 at the distal end to allow easy entry into the hole in the bone tissue.

“The primary purpose of the helical channel 53 is to carry bone-fragment crumbs deposited in the bone-tissue hole prior to installation of the implant 47 away from the distal end and distribute them throughout the threaded portion of the implant. The helical channel 53 also provides a place for packing bone-fragment crumbs prior to installation of the implant.

“The threaded portion of the implant 47 also includes diametrical holes 57 through the implant at various levels along the axis of the implant and connecting to the helical channel 53. The purpose of the holes is to provide receptacles for packing crumbled bone tissue prior to installation of the implant and avenues for bone tissue growth after installation.

“A hexagonal recess is provided in the proximal end 59 of the implant 51 by means of which a user can engage the implant with a hexagonal driving tool for the purpose of screwing the implant into a receiving hole in bone tissue. The proximal end 59 may also include a tapped hole below the hexagonal recess for the purpose of attaching a prosthesis to the implant. The terminal end 51 can be tapered to assure that the attachment of the prosthesis is accomplished in a secure manner. Other types of driving-tool-engaging means and other types of prosthesis-attachment means can also be used.

“The implant 47 is made of a biocompatible material such as pure titanium or a titanium alloy exemplified by Ti 6Al4V. To encourage bone tissue growth in and around the implant, the implant may be coated or plasma-sprayed with hydroxyapatite. For dental applications, the diameter of the implant is typically in the range from 3 to 4 mm with lengths ranging from 6 to 16 mm. The diameter of a femoral implant typically ranges from 6 mm to 16 mm with lengths ranging from 140 to 190 mm.” (FIG. 5 of U.S. Pat. No. 5,676,545 is shown and referred to herein as FIG. 2 titled “Prior Art 2”).

The present disclosure is generally directed to an implant, designed to accommodate and/or handle bone chips and/or tissue fragments and/or remnants. One possible embodiment of the present disclosure may be as a dental implant; however, other types of implants, particularly those that are intended to be implanted in various bone tissues, may be included in the scope and spirit of the present disclosure. The present disclosure may be further directed to a method if applying such implants.

It would be desirable to have an implant that, when attempting screwing into a tissue, such as bone tissue, will allow bone chips and/or tissue remnants to accumulate, so as to avoid or reduce healthy tissue displacement by the implant. Such displacement may cause undesirable pressure on walls of a bore in which the implant is inserted, and/or may hinder healing and/or osseointegration. It would be further desirable to have a method of applying such implants so as to avoid and/or reduce bone chips and/or tissue remnants from accumulating about the implant.

It may also be desirable to form an implant which may accommodate such bone chips and/or tissue remnants and/or fragments.

It may be further desirable that such bone chips and/or tissue remnants and/or fragments will assist, during and/or after osseointegration, in preventing the implant from unscrewing, and to disclose a method of achieving that.

Therefore, there currently exists a need in the industry for an implant and associated method which facilitate the above. This may be attained with the subject matter in accordance with the claims.

### SUMMARY

In The following disclosure, aspects thereof are described and illustrated in conjunction with systems and methods which are meant to be exemplary and illustrative, not limiting in scope. In various embodiments, one or more of the above-described issues and/or desirable effects have been addressed, while other aspects are directed to effect other advantages or improvements.

The present disclosure is broadly related to an implant designed for implantations in bone, and to a method associated with the aforementioned implant. With respect to the implant, it is a generally shaped as a screw, or as a pin, which may be capable of being implanted into bone tissues during an implant procedure, and/or may additionally or alternatively be capable of collecting and/or accumulating bone chips and/or tissue remnants and/or fragments to facilitate osseointegration, and/or may additionally or alternatively be capable of resisting, or tendering to resist, at least partially, unscrewing, after the implant has set (i. e., after osseointegration).

The implant to which the present disclosure relates may comprise an implant body having a longitudinal axis L defining an apical-to-distal direction, An implant comprising an implant body having a longitudinal axis L defining an apical-to-distal direction, the implant body comprises at least one flute, the at least one flute extends from a flute apical region adjacent an implant apical end towards a flute distal region adjacent the distal end, wherein the at least one flute comprises at least one secondary depression located between the flute apical region, and the flute distal region.

Optionally, the at least one flute may open towards the implant apical end, and be deposited about the implant body at a helix angle ξ. The helix angle ξ may be uniform or may vary along an extent of the at least one flute.

Potentially, the flute apical region may be disposed at a different apical helix angle ξa of the flute apical region than a distal helix angle ξd of the flute distal region. The helix angle ξ may be positive, and may vary from about +5 [deg.] to about +65 [deg.]. Alternatively, the apical helix angle ξa may be positive and the distal helix angle ξd may be negative.

Potentially, the at least one flute may define a rake face of the implant body, the rake face extending away from a flute floor towards an edge, the rake face being formed at a positive rake angle ρ which may be angled at an acute angle to a radius vector r extending towards the edge and away from the longitudinal axis L.

The method to which the present disclosure may relate to is a method of applying an implant to bone tissue, comprising steps of: Providing an implant comprising an implant body having a longitudinal axis L defining an apical-to-distal direction, the implant comprising at least one flute formed therein and extending helically at a helix angle ξ; providing the at least one flute with a flute apical region adjacent an implant apical end and opening thereto, and with a flute distal region adjacent the distal end; providing the at least one flute with at least one secondary depression positioned between the flute apical region and the flute distal region; and, applying the implant body to a bone tissue, so that bone chips and/or tissue remnants and/or fragments may be transported along the at least one flute towards the at least one secondary depression, and may accumulate therein.

Possibly, the at least one flute may be provided with a rake face, the rake face being formed at a positive rake angle p which may be angled at an acute angle to a radius vector r extending towards an edge and away from the longitudinal axis L, so that when implanting the implant in a bone, the positive rake angle ρ may be employed to shave, trim, cut, or peel bone chips and/or tissue remnants and/or fragments, which the positive rake angle ρ may further assist in collecting such bone chips and/or tissue remnants and/or fragments to be transported and/or accumulated in the at least one flute.

In addition to the exemplary aspects and embodiments described above, further aspects and embodiments will become apparent by reference to the figures and by study of the following detailed descriptions.

### BRIEF DESCRIPTION OF THE DRAWINGS

Exemplary embodiments are illustrated in referenced figures and drawings. It is intended that the embodiments and figures disclosed herein are to be considered illustrative rather than restrictive.

Reference will now be made to the accompanying drawings, in which:

FIG. 1a, titled “Prior Art 1”, shows FIG. 4 of U.S. Pat. No. 5,897,319;

FIG. 1b, titled also “Prior Art 1”, shows FIG. 5 of U.S. Pat. No. 5,897,319;

FIG. 2, titled “Prior Art 2”, show FIGS. 4 and 5 of U.S. Pat. No. 5,676,545;

FIG. 3 is a schematic perspective rendering of a general, illustrative embodiment of an implant, in accordance with the present disclosure;

FIG. 4 is a schematic side view of the general, illustrative implant, illustrated in FIG. 3, showing a flute distal region and a flute apical region of an at least one flute of the implant;

FIG. 5 is a schematic cross-section view of the general, illustrative implant, illustrated in FIG. 4, taken from an apical end of the implant, along lines V-V;

FIG. 6 is a schematic perspective rendering of a general, illustrative embodiment of another implant, in accordance with the present disclosure;

FIG. 7 is a schematic side view of the another implant, illustrated in FIG. 6, showing a flute apical region and a flute distal region of an at least one flute of the another implant.

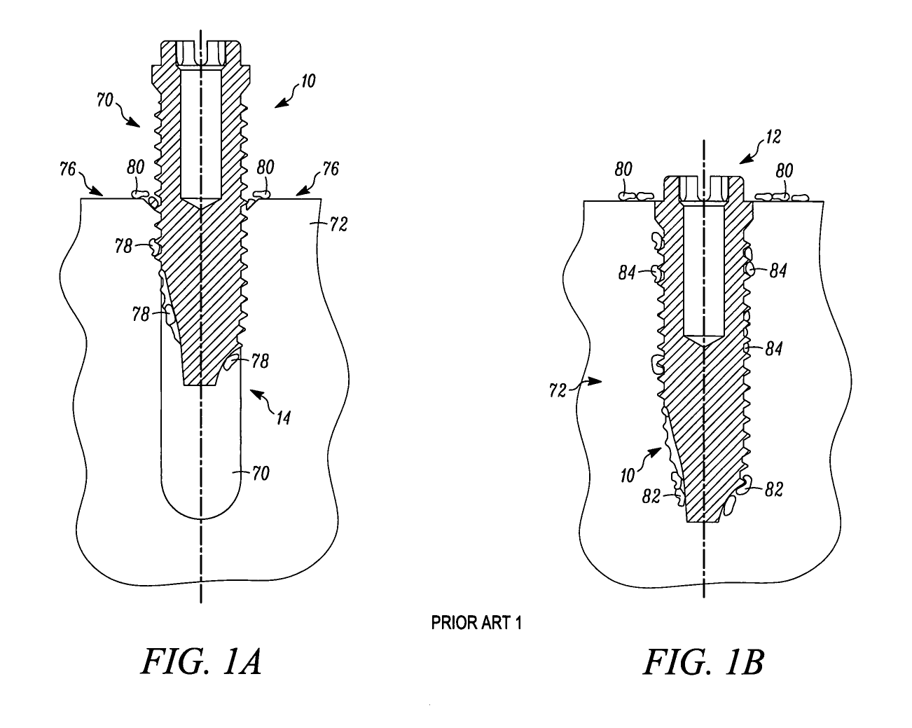

### DETAILED DESCRIPTION

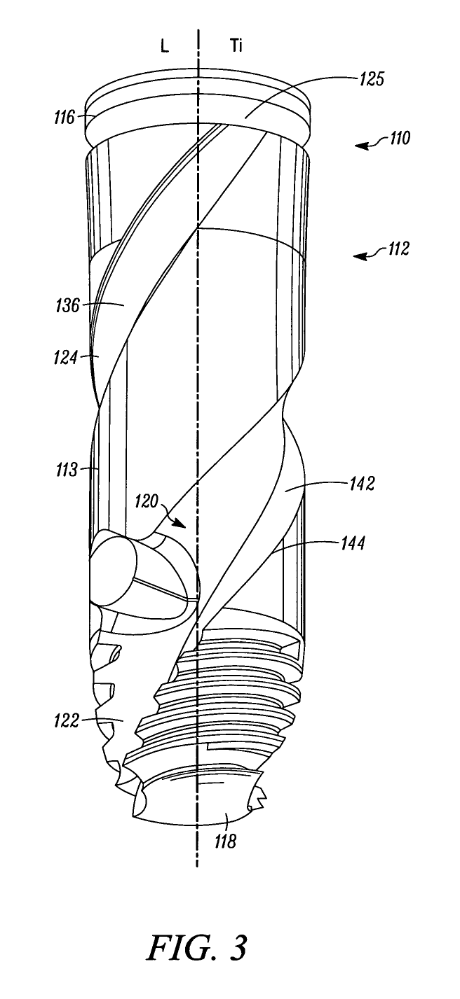

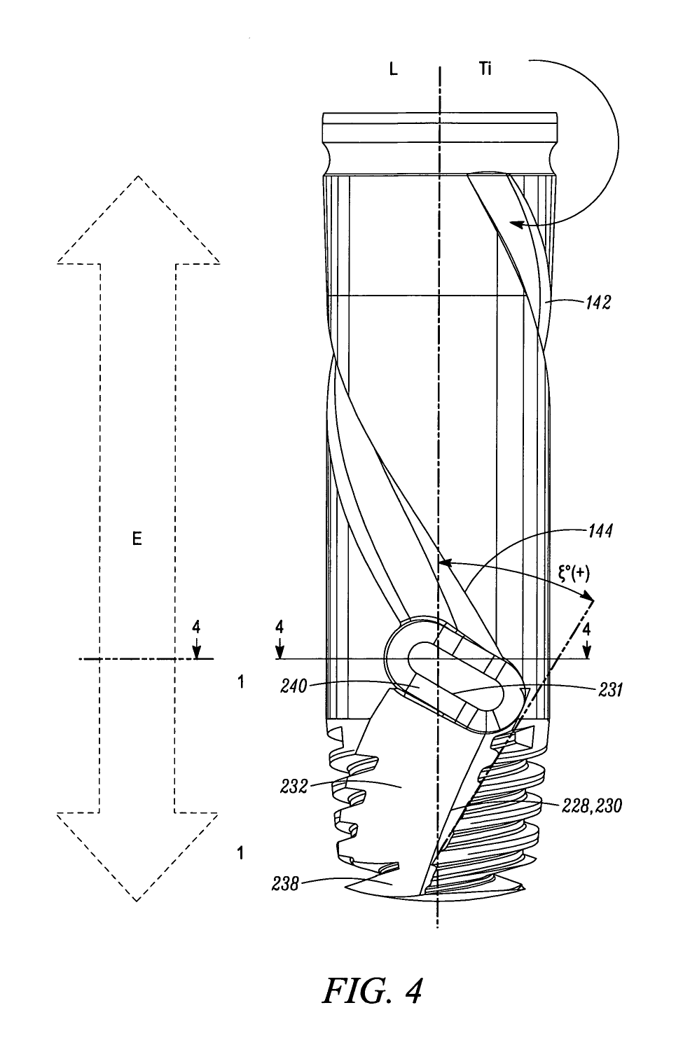

Attention is drawn to FIGS. 3 and 4, schematically illustrating an exemplary embodiment of the present disclosure. An implant 110 may comprise an implant body 112 which may releasably secure a screw or a bolt (not shown), in a substrate (not shown) and/or may comprise an integral abutment (i.e., so called “one piece implants”, not shown), to be embedded in the substrate (not shown). For illustrative purposes only, such substrates may include, but are not limited to, bone or osseous tissues (see http://en.wikipedia.orewiki/Bone tissue, http://en.wikipedia.org/wiki/Osseous_tissue, incorporated herein by reference). The implant body 112 may receive optional and/or additional components and/or assemblies (not shown), which may combine to comprise the implant 110.

The implant body 112 has a distal end 116 and an apical end 118, defining a longitudinal axis L extending therebetween, and a circumferential threading-indirection Ti. The implant body 112 may be of various general shapes, such as, but not limited to, generally cylindrical, generally conical and/or generally frusto-conical. Such general terms as “generally cylindrical”, “generally conical”, and/or “generally frusto-conical” are used herein to describe a body that is substantially rotationally symmetric about an axis that extends from the distal end 116 to the apical end 118.

The implant body 112 may be threaded, smooth or non-threaded (i. e., similarly to a pin), and/or be partially threaded, and partially smooth or non-threaded. If threaded, the thread may be of any of a variety of forms known or discovered to be effective for embedding the implant in bone. The thread may include self-threading (thread cutting) features or other features that may aid in embedding the another implant 110 into bone, or that may promote osseointegration.

It will be appreciated that a screw thread is not rotationally symmetric in the strictest sense, however a screw thread or similar feature is intended to be included by the term “substantially rotationally symmetric.” The implant body 112 of the implant 110 may include features such as the aforementioned screw thread or threads formed about a core 113 of the implant body 112 and other features such as shoulders (not shown), tapered portions (not shown) and the like, all of which are intended to be included by the term “generally cylindrical.” The core 113 of the implant body 112 may be generally cylindrical and/or generally conical and/or generally frusto-conical. At least a portion of the implant body 112 may include an external thread having a pitch.

The implant body 112 may comprise at least one flute 120 extending generally helically away from the apical end 118 towards the distal end 116 of the implant body 112, as well as radially inwardly into the core 113. The flute 120 may comprise a flute apical region 122 adjacent the apical end 118 of the implant 110 and opening thereto, and a flute distal region 124 extending towards the distal end 116 of the implant 110. The at least one flute 120 is configured to aid in inserting the implant 110 and will be discussed in greater detail below. The distal end 116 of the implant body 112 may comprise a peripherally extending channel 125, which the flute distal region 124 opens thereto, and connects therewith.

The at least one flute 120 may be configured and/or implemented as a generally helical shape. Further, the at least on flute 120 may be adapted to cut, or remove bone and/or tissue, when the implant 110 is rotated in circumferential threading-indirection Ti, as will be further elaborated below. Furthermore, the at least one flute 120 may be configured to allow the implant 110 to be rotated in a direction away from the circumferential threading-indirection Ti without cutting or removing bone and or tissue. However, bone and/or tissue removal may be accomplished by rotating the implant in the circumferential threading-indirection Ti.

Although the figures show the implant 110 with the at least one flute 120 configured to cut bone chips and/or tissue remnants and/or fragments when the implant 110 is implanted in the substrate, and rotated in a certain direction, other suitable flute configurations or flute orientations may also be used. Such suitable flutes or flute orientations may comprise one or more flutes that are configured to cut or provide a tapping function when the implant 110 is rotated in an opposite direction.

As may be seen in FIG. 3 and particularly in FIG. 4, the at least one flute 120 may be disposed about the implant body 112 at a positive helix angle ξ, i. e., extending at an angle to the longitudinal axis L, such that the flute apical region 122 is disposed circumferentially forwardly relative to a flute distal region 124. The helix angle ξ may be generally uniform, or it may deviate to form a concave and/or convex flute section. When, during rotation of the implant 110 in the circumferential threading-indirection Ti, bone chips and/or tissue remnants and/or fragments which may be cut, or removed, may be accommodated in the at least one flute 120, and may be transported towards the flute distal region 124. The positive helix angle ξ may be selected so as to optimize bone chips and/or tissue remnants or fragments travel along the at least one flute 120 away from the flute apical region 122. The positive helix angle ξ may be fixed, or constant, along an extent E of the at least one flute 120, and/or may vary along the extent E.

The at least one flute 120 may comprise at least one secondary depression 128 formed generally about the at least one flute 120. In the exemplary embodiment illustrated, for example in FIG. 4, the at least one exemplary embodiment 128 takes a tear-drop shape. However, the at least one secondary depression 128 may take several shapes and/or forms.

The at least one secondary depression 128 may extend from an entry 132 to a terminus 134, generally along a depressed portion 136 of the at least one flute 128. Generally, the entry 132 may be disposed adjacent the flute apical region 122 and the terminus 134 may be disposed adjacent the flute distal region 124. The entry 132 may be sharp, i. e., form a sudden or an abrupt drop from a flute floor 138 to a depression floor 140. Alternatively, the entry 132 may be gradual, i. e., sloping transition from the flute floor 138 to the depression floor 140.

The entry 132 may function differently, depending on the nature thereof. The sudden, or the abrupt, drop may be employed to assist in resisting extraction of the implant body 112 from the bone tissue, after osseointegration. The gradual or sloping transition may assist in bone chips and/or tissue remnants and/or fragments flow into the at least one depression 128.

The at least one secondary depression 128 may be disposed at various positions about the at least one flute 120. As an illustrative, non-binding example, such positions may include, but not be limited to, an apical position, i. e., disposed towards, or adjacent to, the flute apical region 122; a distal position, in which the at least one secondary depression 128 may be disposed towards the flute distal region 124 of the at least one flute 120; or, an approximately middle position, in which the at least one depression 128 may be disposed at an interim position, generally, but not necessarily exactly, between the flute apical region 122 and the flute distal region 124. In the schematic, exemplary embodiment shown in FIGS. 3 and 4, an apical middle middle position 131 is generally illustrated.

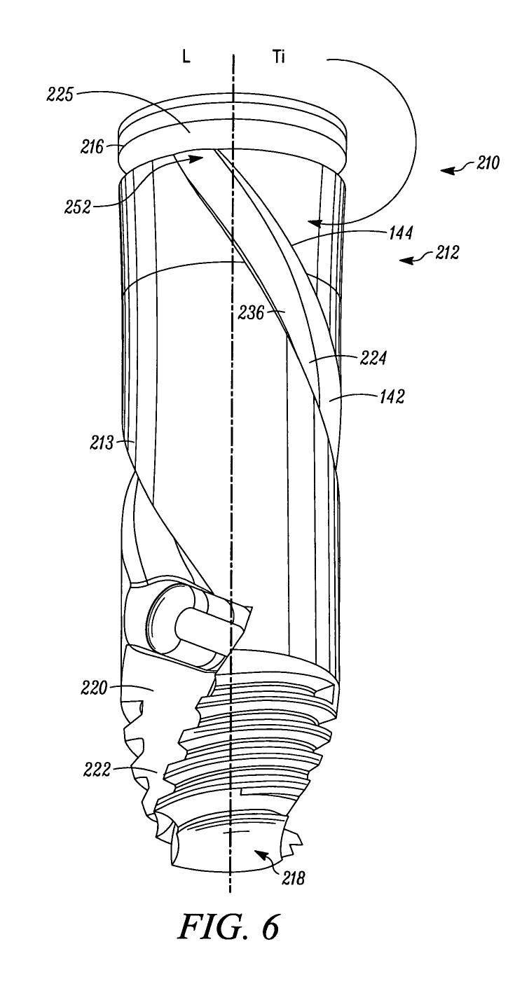

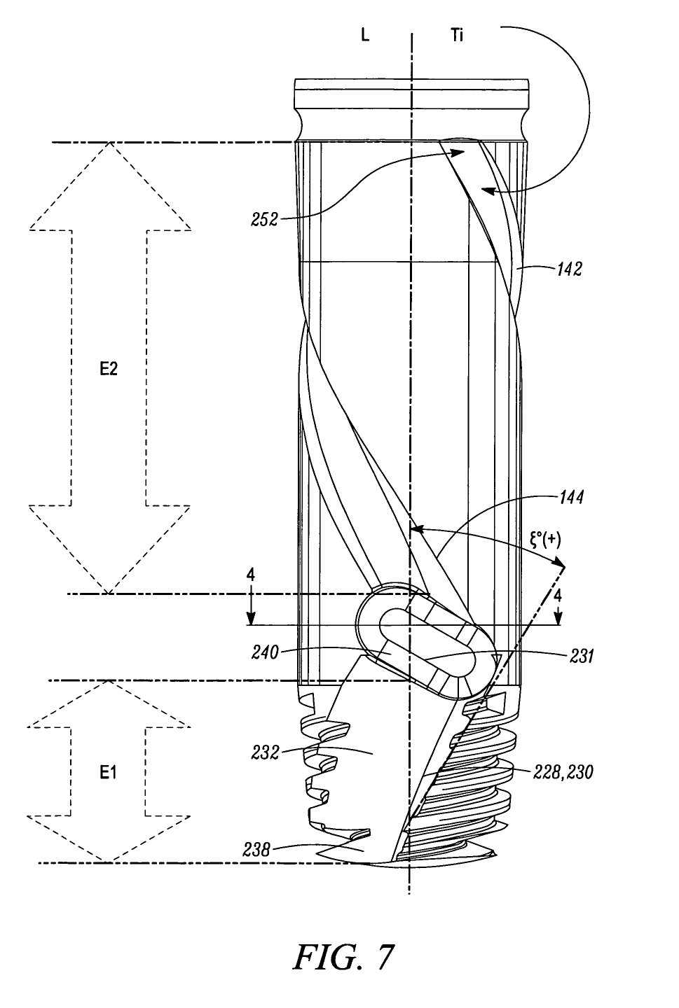

FIGS. 6 and 7 illustrate an exemplary another implant 210 that may also embody the present disclosure. The another implant 210 embodiment may include many features that are similar to the another implant 110 illustrated by FIGS. 3 and 4. Similar features for the another implant 210 have been given reference numerals that are the reference numerals used for another implant 110 increased by 100. For convenience in description, the another implant 210 will be related to as comprising an another implant body 212 extending along a longitudinal axis L between a distal end 216 and an apical end 218, defining a longitudinal axis L extending therebetween, and a circumferential threading-indirection Ti.

The another implant body 212 of the another implant 210 may be related to as “generally cylindrical”, “generally conical”, and/or “generally frusto-conical”. Limitations related to the terms “generally cylindrical”, “generally conical”, and/or “generally frusto-conical” used above in relation to the another implant 110 may also apply to the another implant 210. Similarly to the another implant 110 and its another implant body 112, the another implant body 212 of the another implant 210 may be wholly or partially threaded, with limitations which apply to the another implant 110 may also apply to the another implant 210.

The another implant body 212 may comprise at least one flute 220 extending generally helically away from the apical end 218 towards the distal end 216 of the another implant body 212, as well as radially inwardly into a core 213. The flute 220 may comprise a flute apical region 222 adjacent the apical end 218 of the another implant 210 and opening thereto, and a flute distal region 224 extending towards the distal end 216 of the another implant 210. The at least one flute 220 is configured to aid in inserting the another implant 210 and will be discussed in greater detail below. The distal end 216 of the another implant body 212 may comprise a peripherally extending channel 225, which the flute distal region 224 opens thereto, and connects therewith.

The at least one flute 220 may be configured and/or implemented as a generally helical shape. Further, the at least on flute 220 may be adapted to cut, or remove bone and/or tissue, when the another implant 210 is rotated in circumferential threading-indirection Ti, as will be further elaborated below. Furthermore, the at least one flute 220 may be configured to allow the another implant 210 to be rotated in a direction away from the circumferential threading-indirection Ti without cutting or removing bone and or tissue. However, bone and/or tissue removal may be accomplished by rotating the another implant in the circumferential threading-indirection Ti.

Although the figures show the another implant 210 with the at least one flute 220 configured to cut bone chips and/or tissue remnants and/or fragments when the another implant 210 is another implanted in the substrate, and rotated in a certain direction, other suitable flute configurations or flute orientations may also be used. Such suitable flutes or flute orientations may comprise one or more flutes that are configured to cut or provide a tapping function when the another implant 210 is rotated in an opposite direction.

The at least one flute 220 may comprise at least one secondary depression 228 formed generally about the at least one flute 220. In the exemplary embodiment illustrated, for example in FIG. 7, the at least one secondary depression 228 may take an elongated, rounded-corners and/or chamfered rectangular shape, which may also be known as a general, super-ellipsoid shape (see, as an illustrative example only, http://www.procato.com/superellipse/, http://www.matematiksider.dk/hein/superellipse_bord.gif). However, the at least one secondary depression 228 may take several shapes and/or forms.

The at least one secondary depression 228 may be disposed at various positions about the at least one flute 220. As an illustrative, non-binding example, such positions may include, but not be limited to, an apical position, i. e., disposed towards, or adjacent to, the flute apical region 222; a distal position, in which the at least one secondary depression 228 may be disposed towards the flute distal region 224 of the at least one flute 220; or, an approximately middle position, in which the at least one depression 228 may be disposed at an interim position, generally, but not necessarily exactly, between the flute apical region 222 and the flute distal region 224. In the schematic, exemplary embodiment shown in FIGS. 6 and 7, a general position which may be termed apical middle position 131 is generally illustrated.

As may be seen in FIG. 6 and particularly in FIG. 7, the at least one flute 220 may be disposed about the implant body 212 of the another implant 210 at a helix angle ξ, i. e., extending at an angle to the longitudinal axis L. The helix angle ξ may be generally uniform, or it may deviate to form a concave and/or convex flute section. Generally, the flute apical region 222 may be disposed about the implant body 212 at a positive helix angle ξ, i. e., with a flute apical point 240 where the flute apical region 222 meets the apical end 218 of the another implant 210 is disposed circumferentially forwardly relative to the at least one secondary depression 228. The flute distal region 224, on the other hand, may be disposed about the implant body 212 at a negative helix angle ξ, i. e., with a flute distal point 252 where the flute distal region 224 adjacent the apical end 216 of the another implant 210 is disposed circumferentially forwardly relative to the at least one secondary depression 228. Regarded as a whole, the at least one flute 220 may take a shape similar to a chevron, or a “V” shape.

When, during rotation of the another implant 210 in the circumferential threading-indirection Ti, bone chips and/or tissue remnants and/or fragments which may be cut, or removed, may be accommodated in the at least one flute 120, and may be transported towards the at least one depression 228 both along the flute apical region 222 as well as along the flute distal region 224. The positive and/or negative helix angles ξ may be selected so as to optimize bone chips and/or tissue remnants or fragments travel along the at least one flute 120 away from the flute apical region 222 and also away from the flute distal region 224 to be collected and/or accumulated in the at least one secondary depression 228. The positive and negative helix angles ξ may be fixed, or constant, along an first extent E1 or a second extent E2 of the at least one flute 120, (the first extent E1 being an apical extent of the flute apical region 222 and the second extent E2 being a distal extent of the flute distal region 224) and/or may vary along the first and second extents E1, E2. It may be noted that the extent E may be considered as approximately the combined first and second extents E1, E2).

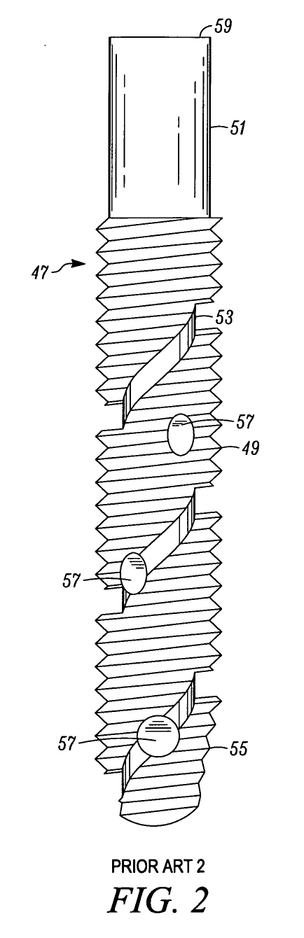

Reference will now be made to both of the exemplary embodiments of the implant 110 and the another implant 210 disclosed herein above. The at least one secondary depression 128, 228 may serve several purposes. One possible such purpose is to accumulate and/or contain bone chips and/or tissue remnants and/or fragments, which may be cut, or removed, and may further be transported away from the flute apical region 122, and, depending on the embodiment, towards the flute distal region 124 of the implant 110, or away from the flute distal region 224 of the another implant 210. Such bone chips and/or tissue remnants and/or fragments may assist in establishing a healthy, healed, and/or healing tissues after the implant procedure, whereas bone chips and/or tissue remnants and/or fragments which otherwise had not been accumulated or contained, may disperse about the implant (as can be seen in FIG. 2, “Prior Art 2”) and may cause pressure on tissues and/or hinder healing or may cause discomfort.

Another optional purpose of the at least one secondary depression 128, 228 may possibly be to alleviate, or reduce, rotation tendencies of the implanted implant 110 and/or another implant 210. When bone chips and/or tissue remnants and/or fragments, which may accumulate in the least one secondary depression 128, may heal and/or go through osseointegration, the least one secondary depression 128 may function similarly to a keyway or keyseat (see http://en.wikipedia.org/wiki/Kevjengineering), which, while relating to machinery parts, may provide a rough idea concerning structure or functions of keyways or keyseats). More specifically, and more related to implants designed to be implanted in bone tissue and to go through osseointegration, such keyways may be employed in enhancing stability of the implanted implant, and/or helping to prevent unscrewing and/or undesirable extraction of the implant.

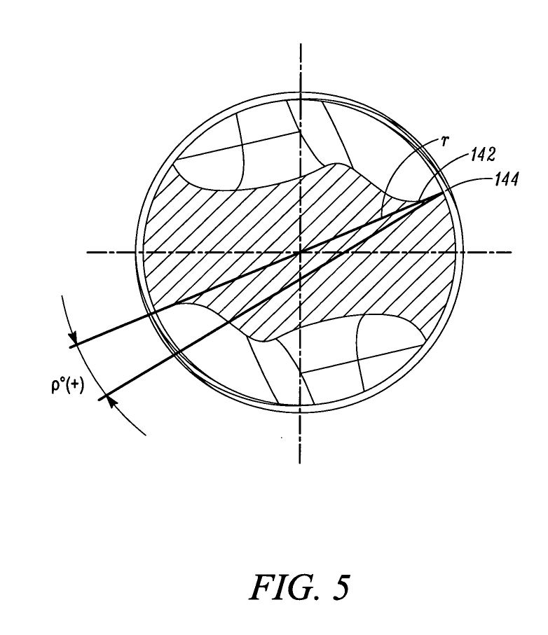

As may be best noticed in FIG. 5, when looking at an axial cross section taken perpendicularly to the longitudinal axis L of the implant body 112, 216 looking away from the distal end 116, 216 the at least one flute 120, 220 defines a rake face 142 extending generally radially away from a flute floor 138 of the implant body 112, 212 to an edge 144. The rake face 142 may be disposed, or formed, at a positive rake angle ρ (may be bast seen in FIG. 5) which may be angled at an acute angle to a radius vector r extending from a geometric center O of the implant body 112 to the edge 144. Such positive rake angle ρ may be beneficial in assisting to shave, trim, cut, or peel bone chips and/or tissue remnants and/or fragments, rather than tearing them off, to assist in collecting such bone chips and/or tissue remnants and/or fragments to be transported and/or accumulated in the at least one flute 120, 220. When collected, such bone chips and/or tissue remnants and/or fragments may avoid gathering about the implant body 112, 212 and potentially assist in reducing pressure which may be created during the implant procedure and which may adversely affect healing.

The rake angle ρ may be constant along an extent E of the at least one flute 120, 220. Alternatively, the rake angle ρ may vary from a positive value at, or adjacent, the flute apical region 122, to a less positive value, or even to a negative value, as the at least one flute 120, 220 extends away from the flute apical region 122, 212 towards the flute distal region 124, 214. This may assist in helping to accumulate and/or contain bone chips and/or tissue remnants and/or fragments within the at least one flute 120, 220, and may further be of use when transporting such bone chips and/or tissue remnants and/or fragments along the at least one flute 120, 220.

All directional references (such as, but not limited to, upper, lower, upward, downward, left, right, leftward, rightward, top, bottom, above, below, vertical, horizontal, clockwise, and counterclockwise, tangential, axial and/or radial) are only used for identification purposes to aid the reader's understanding of the embodiments of the present disclosure, and may not create limitations, particularly as to the position, orientation, or use unless specifically set forth in the claims. n some instances, components are described with reference to “ends” having a particular characteristic and/or being connected with another part. However, those skilled in the art will recognize that the present disclosure is not limited to components which terminate immediately beyond their points of connection with other parts. Thus, the term “end” should be interpreted broadly, in a manner that includes areas adjacent, rearward, forward of, or otherwise near the terminus of a particular element, link, component, part, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure. It is intended that all matter contained in the above description or shown in the accompanying drawings shall be interpreted as illustrative only and not limiting. Changes in detail or structure may be made without departing from the spirit of the disclosure as defined in the appended claims.

While certain exemplary aspects and/or embodiments have been broadly described and/or schematically illustrated in the accompanying drawings, it is to be understood that such aspects and/or embodiments are merely illustrative of, and not restrictive on, the broad present disclosure; further, those of skill in the art may recognize that the present disclosure may not be limited to the specific constructions and arrangements shown and described, since various other modifications, permutations, additions and sub-combinations may occur to those ordinarily skilled in the art, without detracting from the spirit and scope of the present disclosure. It is to be understood that individual features shown or described for one embodiment may be combined with individual features shown or described for another embodiment. It is to be understood some features may have been shown or described to illustrate the use of the present disclosure in the context of functional implants and such features may be omitted within the spirit and scope of the present disclosure.

1. An implant comprising an implant body having a longitudinal axis L defining an apical-to-distal direction, the implant body comprises at least one flute, the at least one flute extends from a flute apical region adjacent an implant apical end towards a flute distal region adjacent the distal end, wherein the at least one flute comprises at least one secondary depression located between the flute apical region, and the flute distal region.

2. The implant of claim 1, wherein the at least one flute opens towards the implant apical end.

3. The implant of claim 1, wherein the at least one flute is deposited about the implant body at a helix angle ξ.

4. The implant of claim 3, wherein the helix angle ξ is uniform.

5. The implant of claim 3, wherein the helix angle ξ varies along an extent of the at least one flute.

6. The implant of claim 3, wherein the flute apical region is disposed at a different apical helix angle ξa of the flute apical region than a distal helix angle ξd of the flute distal region.

7. The implant of claim 3, wherein the helix angle ξ is positive.

8. The implant of claim 7, wherein the helix angle ξ may vary from +5 [deg.] to +65 [deg.].

9. The implant of claim 6, wherein the apical helix angle ξa is positive and the distal helix angle ξd is negative.

10. A method of applying an implant to bone tissue, comprising steps of:
providing an implant comprising an implant body having a longitudinal axis L defining an apical-to-distal direction, the implant comprising at least one flute formed therein and extending helically at a helix angle ξ;
providing the at least one flute with a flute apical region adjacent an implant apical end and opening thereto, and with a flute distal region adjacent the distal end;
providing the at least one flute with at least one secondary depression positioned between the flute apical region and the flute distal region;
wherein, the method comprises applying the implant body to a bone tissue, so that bone chips and/or tissue remnants and/or fragments may be transported along the at least one flute towards the at least one secondary depression, and may accumulate therein.

11. The method of claim 10, wherein the helix angle ξ is uniform.

12. The method of claim 10, wherein the helix angle ξ varies along an extent of the at least one flute.

13. The implant according to claim 1, wherein the implant body comprises at least one flute, the at least one flute defines a rake face of the implant body, the rake face extending away from a flute floor towards an edge, the rake face being formed at a positive rake angle ρ which may be angled at an acute angle to a radius vector r extending towards the edge and away from the longitudinal axis L.

14. The method of claim 10, further comprising steps of:
Providing the at least one flute with a rake face, the rake face being formed at a positive rake angle ρ which may be angled at an acute angle to a radius vector r extending towards an edge and away from the longitudinal axis L; wherein
The method comprises utilization of a positive rake angle ρ to shave, trim, cut, or peel bone chips and/or tissue remnants and/or fragments.

15. The method of claim 14, wherein the positive rake angle ρ may further assist in collecting such bone chips and/or tissue remnants and/or fragments to be transported and/or accumulated in the at least one flute.

16. The method of claim 14, wherein the positive rake angle ρ may further assist in collecting such bone chips and/or tissue remnants and/or fragments to be contained by the at least one flute
